(19) United States
(12) Patent Application Publication
(10) Pub. No.: US 2003/0120524 A1
(43) Pub. Date: Jun. 26, 2003

(54) Trading method to accommodate two trading channels

(76) Inventor: Chi-Tsai Lin, Taichung (TW)

Correspondence Address: Cooper & Dunham LLP, 1185 Avenue of the Americas, New York, NY, 10036, US

(21) Appl. No.: 10/032,783

(22) Filed: Dec. 26, 2001

(51) Int. Cl. G06F 17/60

(52) U.S. Cl. 705/5

(57) ABSTRACT

A trading method to accommodate two trading channels has a dynamic distribution step between a web trading channel and a real world trading channel. When each trading channel has ordering process, the dynamic distribution step is executed to recalculate the two allotments of allocable units in the two trading channels and updates the two latest allotments in the two trading channels. Therefore, the method not only gives the company the best economic benefit but also customers get the latest ordering allotments.

### BACKGROUND OF THE INVENTION

1. Field of the Invention

The present invention is a trading method used to accommodate two trading channels, and more particularly to a method that is used to make reservations on a web trading channel and through a real-world trading channel such as a manned reception desk, ticket counter, etc.

2. Description of Related Art

With the continuing development of E-Commerce, most companies and stores want to attract a large number of customers to buy their goods or services from their web sites. Recently, many service companies have begun to offer customers a quick way of making reservations or ordering tickets, so that a portion of the web sites are configured to be virtual counters to service customers by ordering tickets or making reservations.

With reference to FIG. 5, in general, a web site with an ordering process is setup on a database server (50) to store the ordering information and send resident information back to the terminal (not shown) in the services companies. Customers are able to use a terminal (60) to connect to the web site via the web server (51), and the web site can also send messages to customers via the mail server (52). The customer executes the ordering process in the web site and inputs the ordering information including the date, the number of people, the number of reservations (such as seats, tables or rooms), etc. to the web site, where the information is stored in the database server (50) and is sent to terminals of the service companies. The employees in the service companies check availability information on the database server (50) after receiving the ordering information. If the ordered service is available, a successful trade or confirmation message is sent to the customer via the mail server (52) at the e-mail address provided by the customer or by fax (53).

However, most service companies, such as hotels, KTVs, theaters, etc. have a fixed allotment of their services available on the web site for customers to order. A complementary fixed allotment is distributed to a real-world service channel. However, that distribution of the allotment between two trading channels, such as the web site and a service center does not balance with the demand at the individual sites. For example, when a crowd of customers suddenly shows up at one of the trading centers, the allotment of reservations for the trading center is not adequate to fill the customers orders. On the other hand, the other trading channel still has a surplus that may go unsold. That is, the allotments to the two trading channels are fixed, and the trading channel with the surplus cannot offer the surplus to the other trading channel that needs an additional allocation to meet customer demand.

As described above, customers can complete the reservation and ordering process in a short time when they make the transactions on line. However, companies spend so much money to design their web sites to attract more customers that the economic benefits are not obvious.

Therefore, an objective of the invention is to provide a trading method between two trading channels to mitigate and/or obviate the aforementioned problems.

### SUMMARY OF THE INVENTION

The main objective of the present invention is to provide a trading method to accommodate two trading channels that has a dynamic distribution step between a web trading channel and a real-world trading channel. After each trading channel completes an ordering process, the dynamic distribution step is executed to balance the two allotments and update the two allotments in the two trading channels.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of a trading method to accommodate two trading channels in accordance with the present invention;

FIG. 2 is block diagram of a web hardware structure including a terminal and a database server to implement the trading method in FIG. 1;

FIG. 3 is a partial flow chart of the method in accordance with the present invention;

FIG. 4 is the other partial flow chart of a method in accordance with the present invention; and

FIG. 5 is block diagram of a web hardware structure in accordance with conventional on-line ordering process.

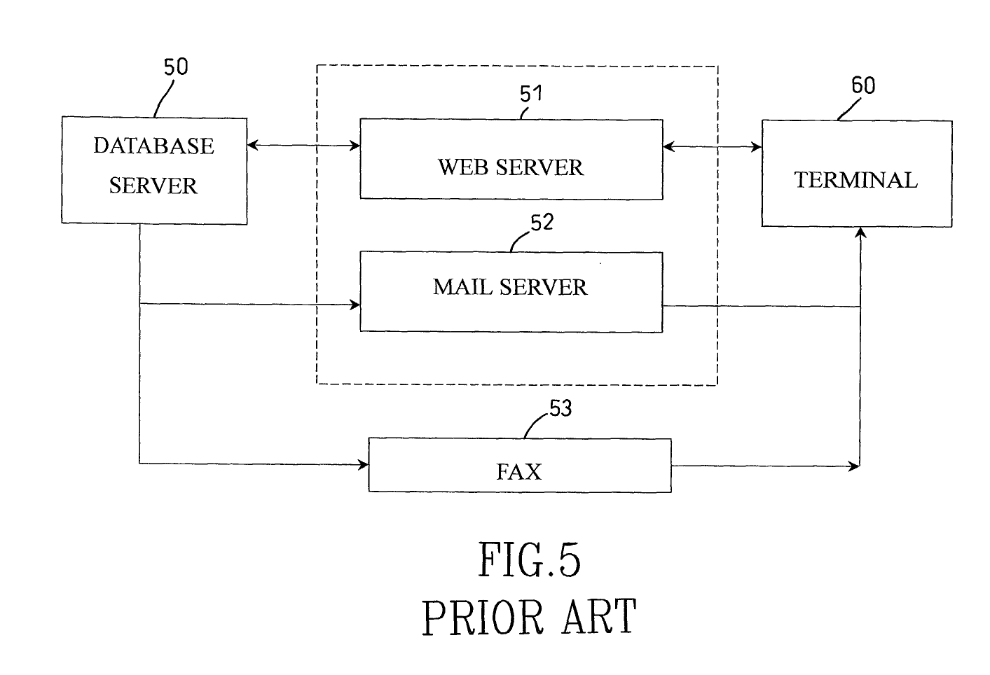

### DETAILED DESCRIPTION OF THE PREFERRED EMBODIMENT

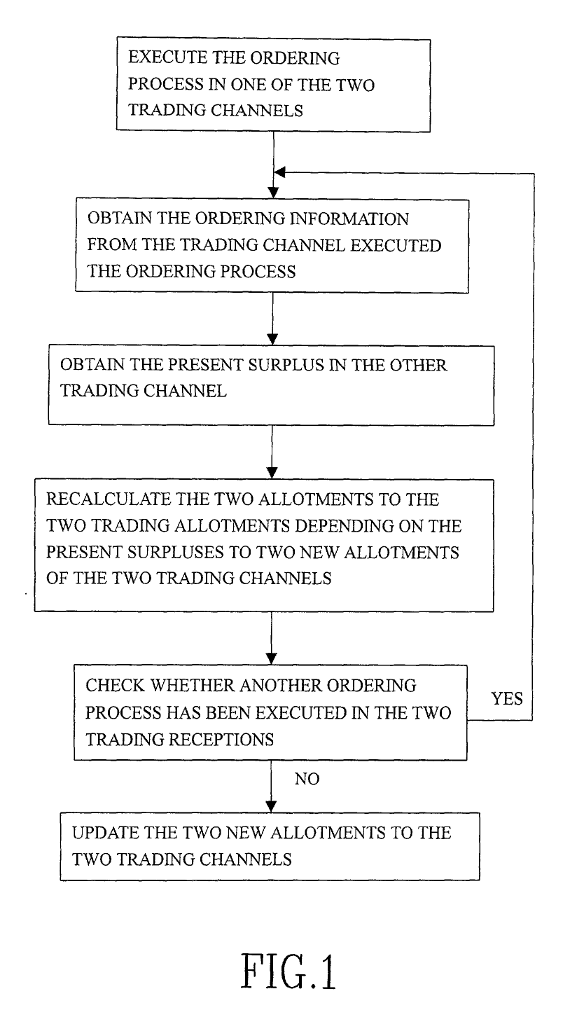

With reference to FIG. 1, a service trading company includes a first trading channel to receive web ordering information and a second trading channel where real-world ordering information is received such as a reception counter, ticket booth, etc. Each trading channel has an allotment from which customer orders are filled. The method comprises the following steps:

executing an ordering process in one of the two trading channels, wherein each trading channel has an allotment of allocable units such as tickets, reservations, etc. from which customer orders are filled. When the customers execute orders, the number of allocable units ordered must be input into the channel, either to the web site through the customer terminal or into the computer at the real-world site by the service personnel. Besides, if the ordered service is available, a successful trade or confirmation message is sent to the customer.

obtaining the ordering information from the trading channel that executed the ordering process, wherein the information includes the surplus of the trading channel and the number of allocable units the customers ordered;

obtaining the present surplus of the allocable units from the other trading channel;

recalculating the two allotments of allocable units in the two trading channels, that is the two surpluses of the two trading channels are used to recalculate new allotments for each channel according to a specified ratio;

detecting whether another ordering process has been executed in the two trading channels, that is, if another customer placed an order during the above processing steps, the surplus at that channel has changed so that the next step is to return to the second step; and

updating the two new allotments from the fourth step in the two trading channels.

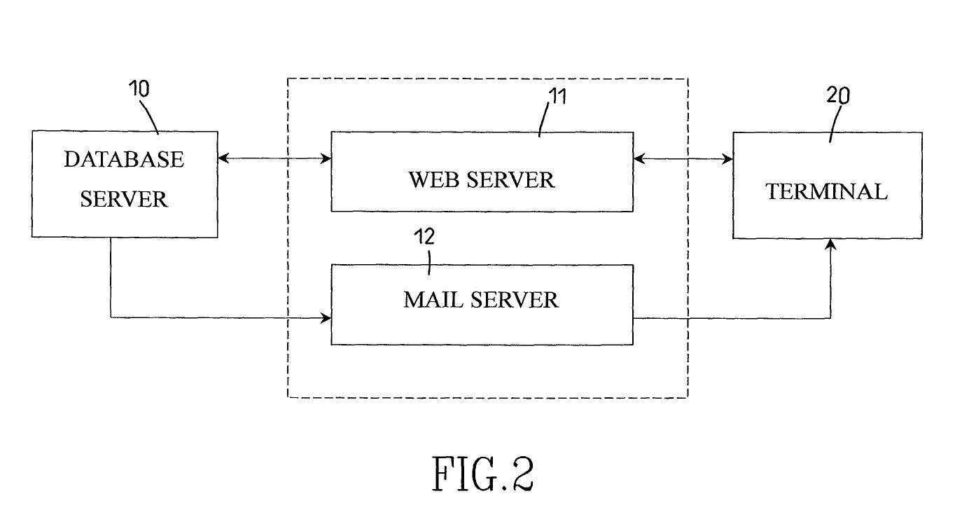

With reference to FIG. 2, an Internet hardware structure between a customer and a web site comprises a database server (10), a web server (11), a mail server (12) and a terminal (20). The database server (10) stores the ordering related information about the web site. The web server (11) is connected to the database server (10). The mail server (12) of the Internet is connected to the database server (10). The terminal (20) is connected to the web server (11) for entering the web site. The customer is able to enter the web site via the terminal (20) and places the order on the web site. The database server (10) connects to a computer (not shown) in the real-world trading channel to transmit the trading information to each other. An operating system is setup in the computer to manage the ordering process at the real-world trading channel.

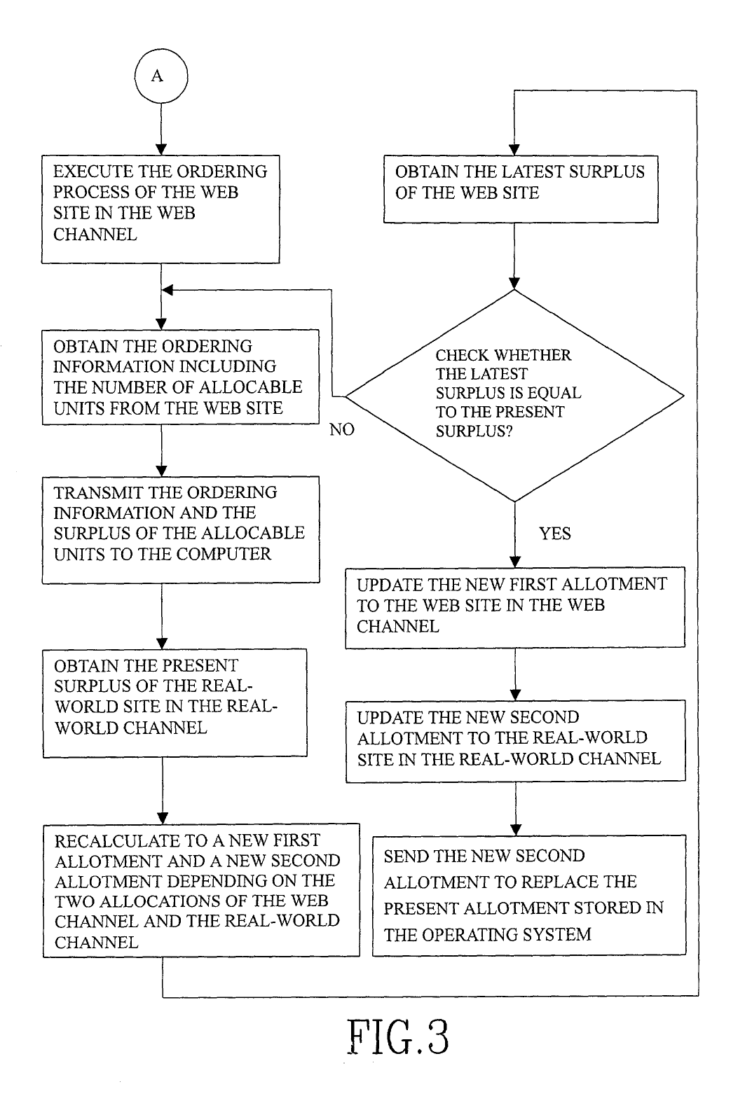

With reference to FIG. 3, when placing an order through the web channel, a customer enters the ordering information on the web site, and the web site ensures that the ordering process is successful. The database server stores the ordering information immediately. The database server sends this information including the allocable units ordered and the surplus of the web site to the computer at the real-world channel. Thereafter the computer obtains the present surplus stored in the operating system in the real-world site, and the two surpluses are recalculated to a new first allotment and a new second allotment depending on the specified ratio. The computer connects to the web site again to check whether the latest surplus on the web site is equal to the present surplus in the computer. If the two surpluses are not equal, another ordering process has already been executed through the web channel during the above steps running. Therefore, the follow-up steps do not run, and process returns to run the first step. If the two surpluses are equal, the computer sends the new first allotment to update the present allotment on the web site and sends the new second allotment to update the present allotment on the operating system in the real-world site. That is the new second allotment replaces the present allotment stored in the operating system. Therefore customers are able to watch the latest allotment of allocable units and decide how many allocable units to order. The real-world channel also controls the latest allotment of allocable units to offer the customers. That is to say, whatever a crowd of people show up on the Internet trading channel or at the real-world trading channel, the two trading channels always adjust the allotments and show them on Internet.

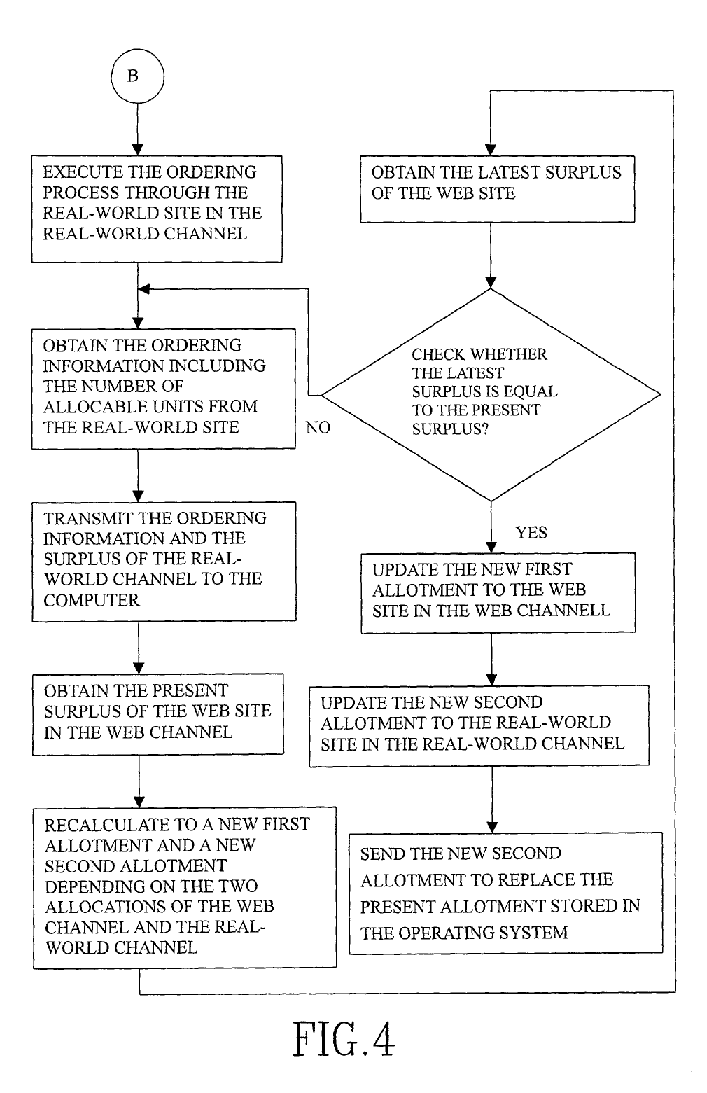

With reference to FIG. 4, when placing an order at the real-world site through the real-world channel, a customer places the order by entering the ordering information into the computer at the real-world channel. Thereafter the computer obtains the present surplus of allocable units stored in the database server, two surpluses of seats are recalculated depending on the specified ratio to a new first allotment and a new second allotment. The computer connects to the web site again to check whether the present surplus of allocable units on the database server is equal to the last surplus sent to the computer. If the two surpluses are not equal, the ordering process of the web site has already been executed during the above steps. Therefore, the follow-up steps do not run, and the process returns to run the first steps. If the two surpluses are equal, the computer sends the new first allotment to update the present allotment on the web site and sends the new second allotment to update the present allotment on the operating system in the real-world site. That is the new second allotment replaces the present allotment stored in the operating system. Therefore the customers are able to watch the latest allotment of allocable units and decide how many allocable units to order. The counter also controls the latest allotment of allocable units to offer the customers. That is to say, whatever a crowd of people show up on the Internet trading channel or in the real-world trading channel, the two trading channels always adjust the allotments and show them on the Internet.

As per the above description, every time the ordering process is executed in the Internet trading channel or the real world trading channel, the two allotments of allocable units are redistributed again to balance the relationship between the two trading channels. That is to say, whatever a crowd of customers suddenly shows up on the Internet trading channel or at the real world trading channel, the two trading channels always adjust the best allotments to fill the customers orders.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A trading method to accommodate two trading channels, wherein two trading channels communicate with each other and receive orders from the web and real world trading, the method comprising:
executing an ordering process in one of the two trading channels, wherein each trading channel has an allotment of allocable units from which customer orders are filled and inputting the number of allocable units they ordered;
obtaining the ordering information from the trading channel that receives the order from the customer, wherein the ordering information includes the surplus of allocable units of the trading channel and the number of allocable units the customers ordered;
obtaining the present surplus of the allocable units from the other trading channel;
redistributing the two allotments of allocable units in the two trading channels, that is the two surpluses of the two trading channels are used to recalculate new allotments for each channel according to a specified ratio;
updating the two new allotments from the fourth step in the two trading centers.

2. The trading method as claimed in claim 1, wherein after the redistributing the two new allotments step, detecting whether another ordering process has been executed step is added to confirm whether the two new allotments are the most current, if the result is no, the obtaining the ordering information step is executed again, and if the result is yes, the updating the two new allotments step is executed.

3. The trading method as claimed in claim 1 wherein after the ordering process in each of the trading channel finishing, a sending trading successful message step is executed to let the customer know the ordering process is successful.

4. The trading method as claimed in claim 1, wherein the allocable units can comprise hotel rooms, tickets for assigned seats, reservations such as restaurants, etc.
